(19) United States
(12) Patent Application Publication
(10) Pub. No.: US 2004/0069973 A1
(43) Pub. Date: Apr. 15, 2004

(54) Intrinsically conductive elastomers

(75) Inventors: Francis L. Keohan, Kingston, MA (US); Edgar D. Lazaro, North Dartmouth, MA (US)

Correspondence Address: Francis L. Keohan, Cape Cod Research, Inc., 19 Research Road, East Falmouth, MA, 02536, US

(73) Assignee: Cape Cod Research, Inc

(21) Appl. No.: 10/270,217

(22) Filed: Oct. 15, 2002

(51) Int. Cl. H01B 1/00

(52) U.S. Cl. 252/500

(57) ABSTRACT

The present invention relates to electrically conductive elastomers comprising (A) an intrinsically conducting polymer, and (B) a block copolymer comprising one or more polydiorganosiloxane and one or more polyether block(s).

The invention was made with Government support under Grant DMI-0109188 awarded by the National Science Foundation. The Government has certain rights in this invention.

### FIELD OF THE INVENTION

The invention relates to organosiloxane compositions that form electrically conductive elastomers, such as those used in solid state applications for electrical connections and wires and the like. The invention more specifically relates to ultraflexible ribbon cables for use with electrical microprobes capable of chronic recording and/or stimulation in the central nervous system. Methods for altering the regeneration, differentiation or differentiated cell function of cells using the invention are taught by Shastri et al in U.S. Pat. No. 6,095,148 which is incorporated herein by reference.

### BACKGROUND OF THE INVENTION

Elastomers are polymeric materials that at room temperature can be stretched to at least twice their original length and upon immediate release of the stress will return quickly to approximately their original length.

Known electrically conductive elastomers are a class of rubber and plastics that have been made electrically conductive by blending the non-conducting polymeric component with an electrically conducting component. Conductive fillers currently in use have problems which include high cost, poor compatibility with physiological fluids, sloughing of the filler, dependency on environmental conditions, and a very high surface resistance.

Intrinsically conductive polymers are completely different from conducting polymers that are merely a physical mixture of a nonconductive polymer with a conducting material such as metal or carbon powder. Their common electronic feature is the π-conjugated system in the polymer backbone that is formed by the overlap of p_{z} orbitals and alternating carbon-carbon bond lengths. Known π-conjugated polymers are rigid elastic materials that can be stretched only a very small fraction of their original length before brittle failure occurs. They have high ultimate tensile stress, high Young's modulus, and no yield stress. Representative intrinsically conductive polymers include polyacetylene, polythiophene and polypyrrole, among many others. In the pure state, these are infusible, unmeltable and unprocessible brittle materials. Useful articles can only be formed as thin films or fibers that are flexible but not useful as elastomers. Furthermore, in the pure state unsubstituted intrinsically conductive polymers are insulators. Their electrical conductivity often results from n- and p-type doping which is very sensitive to oxidation and often requires that dopants diffuse into the rigid polymer during the doping process.

Mechanical properties of intrinsically conductive polymers can be improved by blending intrinsically conductive polymer material with dopants to form shaped articles in a single step. U.S. Pat. No. 6,168,732 discloses polymer blend compositions in which doped intrinsically conductive polymer is substantially uniformly dispersed in the nonconducting (dielectric) polymer compound resulting in an electrically conductive blend. While said blend can be formed into a rigid article suitable for commercial use, it is much too rigid to be formed into an elastomeric article.

By contrast, in a preferred embodiment, the invention is an elastomer suitable for forming electrically conductive elastic articles of commercial use.

The present invention is an electrically conductive material comprising (A) intrinsically conducting polymer, and (B) a block copolymer comprising one or more polydiorganosiloxane and one or more polyether block(s). The resultant polymer blend has dispersion of dissimilar materials at a molecular scale. As opposed to the prior art, preferred materials of the invention are both intrinsically conducting polymers and elastomers.

An advantage of use of the invention is that no external corrosive monomeric or oligomeric dopants are necessary. Furthermore, there is high thermal, chemical and electrical stability. There is also enhanced processability.

It is important to note that because of the interaction of the two dissimilar polymers as stated above, compatible molecularly mixed blends are formed wherein there is no phase separation. Finally, the solution that forms the invention gels over time. This allows the formation of the highdraw ratio fibers needed for ultraflexible ribbon cables.

The invention maintains constant electrical conductivity when exposed to saline solution for extended periods of time. This behavior is very desirable for articles that are exposed to physiological solutions found within the human cranium, arteries and bladder.

### SUMMARY OF THE INVENTION

A broad aspect of this invention is an electrically conductive material comprising: (A) intrinsically conducting polymer, and (B) a block copolymer comprising one or more polydiorganosiloxane and one or more polyether block(s) which, in appropriate composition selections and appropriate composition range, forms an elastomeric article.

In the first embodiment of the present invention, said intrinsically conducting polymer is selected from the group consisting of substituted and unsubstituted polyparaphenylenevinylenes, polyanilines, polyazines, polythiophenes, poly-p-phenylene sulfides, polyfuranes, polypyrroles, polyselenophenes, polyacetylenes, formed from soluble precursors and combinations and blends thereof.

Of these, substituted and unsubstituted polyanilines, polythiophenes and polypyrroles are preferred. One of the attractive features of these two systems is the ability to readily prepare functionalized polymers by polymerization of the appropriate monomer. The nature, number, and ratios of polymers copolymerized with polypyrrole allows systematic modification of the mechanical properties. Furthermore, the environmental stability of these two systems is very good at room temperature in air and saline solutions.

The electrically conductive material of the invention shows an excellent and surprising electrical conductivity while maintaining the elastomeric behavior of known silicone rubbers. No exact mechanism by which this unexpected and surprising result is obtained has been elucidated. It is possible that the structure that results by blending at a molecular level the soluble precursors of said block copolymers comprising silicone elastomeric groups with the soluble precursors of said intrinsically conducting polymers surprisingly provides the invention with the desired combination of electrical conductivity and elastomeric behavior.

The invented material is non-corrosive, electrically conductive, processible and elastomeric, and thus overcomes the disadvantages of the prior art.

### DETAILED DESCRIPTION OF THE PREFERRED EMBODIMENTS

The material of the present invention may be prepared in many ways. A three step method for preparation of the invention is given hereinbelow, by way of example, but not by way of limitation:

The first step involves the synthesis of block copolymer precursors comprising one or more polydiorganosiloxane and polyether block(s). Preferred block copolymers are polysiloxane-poly(alklene ether) terpolymers derived from polysiloxane-polyalkylene ether copolymers and alkenyl-functional polysiloxane monomers or polymers via base-catalyzed equilibration reactions.

Preferred polydiorganosiloxane block(s) comprise(s) 2 or more diorganosiloxane units which are chosen according to the formula:

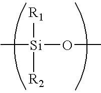

wherein R₁ and R₂ are chosen from the group consisting of methyl, isopropyl, sec-butyl, allyl, phenyl, tolyl, benzyl, —CH₂CH₂CF₃, —CH═CH₂, —(CH₂)ₙ—, —(CH₂)ₙ(OCH₂CH₂)ₓOR₃, —(CH₂)ₙ(OCH₂CH₂)ₓ(OCH₂CH_{CH}₂CH₂)_{y}OR₃ and —(CH₂)ₙ—R₄; wherein n equals an integer from 1 to about 18; the sum of x and y is an integer from 1 to about 5000; R₃is chosen from the group consisting of H and CH₃; and R₄ is chosen from the group consisting of substituted and unsubstituted paraphenylenevinylenes, anilines, azines, thiophenes, p-phenylene sulfides, furanes, pyrroles, selenophenes, and acetylenes.

Especially preferred polydiorganosiloxane block(s) contain about 4 to about 500 diorganosiloxane units and at least half of R₁ and R₂ are methyl radicals. While the length of the groups pendant to the main chain can vary widely, the preferred combination of elasticity and electrical conductivity can best be achieved when n equals three.

Preferred polyether block(s) comprise one or more ether units which are chosen from the group consisting of ethylene oxide and propylene oxide. The preferred combination of elasticity and electrical conductivity can best be achieved when said ether units range in number from about 5 to about 500.

The second step involves blending said block copolymer precursors with monomers that can be polymerized into intrinsically conducting polymers using water and/or alcohols as the principal solvent. Of these, methanol and lower aliphatic alcohols are especially preferred. A preferred embodiment is the mixing of said precursors and said monomers at the molecular scale in a single phase liquid mixture.

The third step involves polymerizing the monomers into intrinsically conducting polymers while simultaneously forming and crosslinking the block copolymers to yield the material of invention.

The ratio of components in the blend as well as the choice of solvent will vary depending upon the desired properties needed to accomplish the objective. In order to meet such requirements as the need to provide a shaped product having a useful amount of physical strength while electrically insulated from the environment, the shaped articles of this invention are preferably prepared by a fourth step of incorporation into an encapsulating and insulating elastomeric polymer, such as a polysiloxane.

In order to demonstrate the invention in greater detail, the following illustrative examples are included. It will be appreciated, therefore, that examples provided herein are for purposes of illustration only and are not to be regarded as a restriction upon the scope of the claims, inasmuch as those skilled in the art may depart from these specific examples without actually departing from the spirit and scope of the present invention.

### EXAMPLE 1

### Syntheses of Block Copolymer Precursors

The polydiorganosiloxane precursors of the present invention provide the processing characteristics of room temperature curing silicone elastomers along with solubility in aqueous solvents. They may be derived from polysiloxane-polyalkylene ether copolymers and alkenyl-functional polysiloxane monomers or polymers via base-catalyzed equilibrium reactions.

In a preferred embodiment, 12.1 w % polydimethylsiloxane (ethoxylate/propoxylate) dihydroxy terminated (CAS: 68937-54-2 sold by Geleste, Inc. Tullytown, Pa. 19007-6308), 82.8w % tetramethylcyclotetra-siloxane (D′4 CAS:2370-88-9), and 5.1 w % tetravinyltetramethyl-cyclotetrasiloxane (CAS:27342-69-4) are “equilibrated”.

As used herein, the terminology “equilibrated” means the polymerization of cyclic polysiloxane monomers to linear polysiloxanes and the insertion of said cyclic polysiloxanes within the linear portions of linear or branched polysiloxanes of copolymers containing linear or branched segments, thus increasing the average molecular weight of the linear polysiloxane.

A representative synthesis involving equilibrating the various components to produce a preferred functionalized silicone terpolymer is:

In a 100 mL round bottom flask, 1.2 g polydimethylsiloxane (ethoxylate/propoxylate) dihydroxy terminated, 8.5g tetramethylcyclo-tetrasiloxane, 0.5 g tetramethyltetravinylcyclotetrasiloxane, and 0.1 g lithium trimethylsilanolate is added and stirred under argon at 70° C. for 12-18 h. The mixture is then treated with Brockman I, acidic alumina and stirred for 30 minutes. The solid alumina catalyst is removed by vacuum filtration, leaving a clear, slightly viscous liquid.

Especially preferred are block copolymer precursors which contain pendant chains terminated by pendant reactive substituents that can chemically graft to the intrinsically conducting polymer. By way of example, but not by way of limitation, this approach is illustrated by the following example using thiophene.

Block copolymer precursors with pendant chains are synthesized by first synthesizing alkenyl-functional thiophene using commercially available reagents such as 3-bromopropene and 3-bromothiophene:

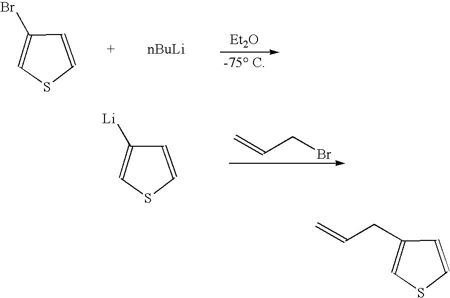

The alkenyl-functional thiophene can be reacted with cyclotetramethylsiloxane using a hydrosilylation catalyst to produce a polythiophene-functional siloxane monomer. The reaction is:

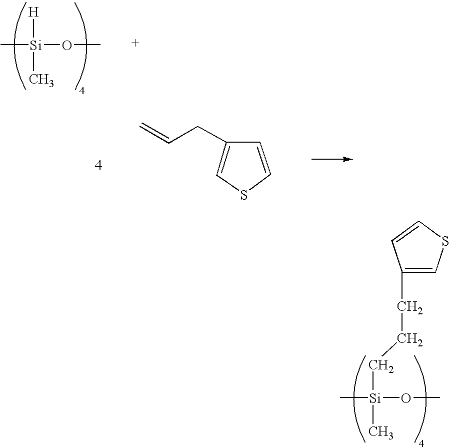

The cyclic thiophene-functional monomer can then be used to modify poly(alkylene ether-polysiloxane) copolymers with grafting sites for bonding directly to the intrinsically conductive polymer in the invention. While it is unnecessary to chemically link the conducting polymer and host polymer to achieve elastomers with superior mechanical properties, this additional modification is preferred for the further improvements in conductivity that result.

The equilibration reaction for synthesizing these elastomeric host polymers that have functionality for covalent grafting to conductive organic polymers are illustrated below.

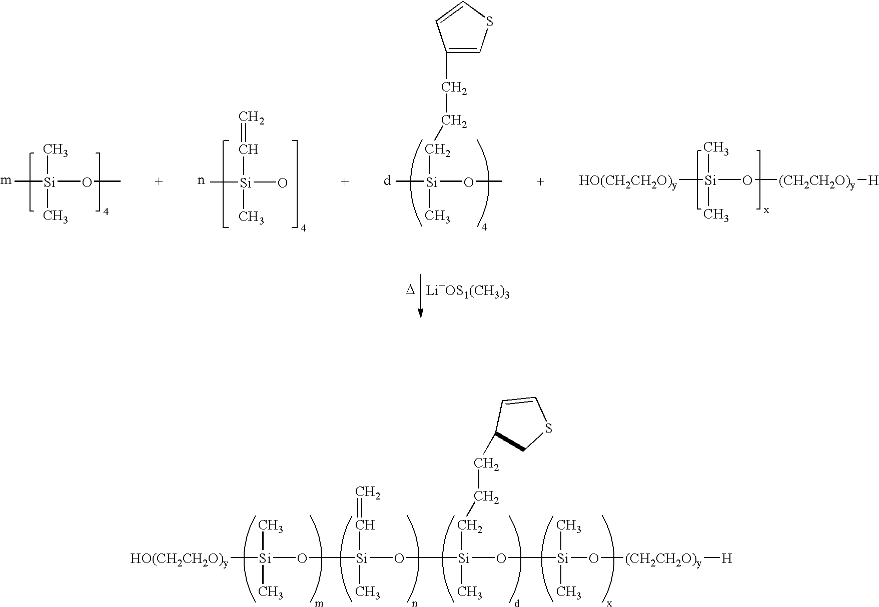

The poly(ethylene oxide-co-dimethyl siloxane-co-methylvinylsiloxane) host terpolymers are prepared by equilibrating cyclic dimethyl-siloxane oligomers, cyclic vinylmethyl siloxane oligomers, and poly(ethylene oxide-co-dimethyl siloxane) copolymers using a basic catalyst such as lithium trimethylsilanolate.

An alkenyl-functional poly(alkylene glycol)-poly(diorganosiloxane) terpolymer composition based on poly(alkylene glycol)-poly(dimethylsiloxane) block copolymers is prepared from the following reagents:

| | Percent by |
|---|---|
| Component | Weight |
| Octamethylcyclotetrasiloxane | 82% |
| Polydimethylsiloxane (ethoxylate/propoxylate) | 12% |
| dihydroxy terminated, CAS No. [68037-63-8] | |
| 1,3,5,7-Tetravinyl-1,3,5,7- | 5% |
| tetramethylcyclotetrasiloxane | |
| Lithium trimethylsilanolate | 1% |

In the formulation provided above, the useful range of the components present in the methylvinylsilyl-functional poly(alkylene glycol)-poly(diorganosiloxane) block terpolymer host constituent may be set forth as follows:

| | Percent by |
|---|---|
| Component | Weight |
| Octamethylcyclotetrasiloxane | 5%-95% |
| Polydimethylsiloxane (ethoxylate/propoxylate) | 1%-50% |
| dihydroxy terminated, CAS No. [68037-63-8] | |
| 1,3,5,7-Tetravinyl-1,3,5,7- | 1%-50% |
| tetramethylcyclotetrasiloxane | |
| Lithium trimethylsilanolate | 1-5% |

An alkenyl-functional poly(alkylene glycol)-poly(diorganosiloxane) terpolymer composition based on poly(alkylene glycol)-poly(dimethylsiloxane) graft copolymers is prepared from the following reagents:

| | Percent by |
|---|---|
| Component | Weight |
| Octamethylcyclotetrasiloxane | 82% |
| Poly[dimethylsiloxane-co-methyl (3- | 12% |
| hydroxypropyl) siloxane]-graft- | |
| poly (ethylene/propylene glycol), CAS No. | |
| [68937-55-3] | |
| 1,3,5,7-Tetravinyl-1,3,5,7- | 5% |
| tetramethylcyclotetrasiloxane | |
| Lithium trimethylsilanolate | 1% |

In the formulation provided above, the useful range of the components present in the methylvinylsilyl-functional poly(alkylene glycol)-poly(diorganosiloxane) terpolymer host constituent may be set forth as follows:

| | Percent by |
|---|---|
| Component | Weight |
| Octamethylcyclotetrasiloxane | 5%-95% |
| Poly[dimethylsiloxane-co-methyl (3- | 1%-50% |
| hydroxypropyl) siloxane]-graft- | |
| poly (ethylene/propylene glycol) CAS No. | |
| [68937-55-3] | |
| 1,3,5,7-Tetravinyl-1,3,5,7- | 1%-50% |
| tetramethylcyclotetrasiloxane | |
| Lithium trimethylsilanolate | 1-5% |

An alkenyl-functional poly(alkylene glycol)-poly(diorganosiloxane) terpolymer composition based on poly(alkylene glycol)-poly(dimethylsiloxane) graft copolymers is prepared from the following reagents:

| | Percent by |
|---|---|
| Component | Weight |
| Octamethylcyclotetrasiloxane | 82% |
| Poly[dimethylsiloxane-co-methyl (3- | 12% |
| hydroxypropyl) siloxane]-graft- | |
| poly (ethylene/propylene glycol) methyl ether, | |
| CAS No. [67762-85-0] | |
| 1,3,5,7-Tetravinyl-1,3,5,7- | 5% |
| tetramethylcyclotetrasiloxane | |
| Lithium trimethylsilanolate | 1% |

In the formulation provided above, the useful range of the components present in the methylvinylsilyl-functional poly(alkylene glycol)-poly(diorganosiloxane) terpolymer host constituent may be set forth as follows:

| | Percent by |
|---|---|
| Component | Weight |
| Octamethylcyclotetrasiloxane | 5%-95% |
| Poly[dimethylsiloxane-co-methyl (3- | 1%-50% |
| hydroxypropyl) siloxane]-graft- | |
| poly (ethylene/propylene glycol) methyl ether, | |
| CAS No. [67762-85-0] | |
| 1,3,5,7-Tetravinyl-1,3,5,7- | 1%-50% |
| tetramethylcyclotetrasiloxane | |
| Lithium trimethylsilanolate | 1-5% |

An alkenyl-functional poly(alkylene glycol)-poly(diorganosiloxane) terpolymer composition based on poly(alkylene glycol)-poly(dimethylsiloxane) block copolymers is prepared from the following reagents:

| | Percent by |
|---|---|
| Component | Weight |
| Octamethylcyclotetrasiloxane | 82% |
| Poly (dimethylsiloxane) ethoxylated | 12% |
| hydroxypropoxylate terminated, CAS No. [68037-63-8] | |
| 1,3,5,7-Tetravinyl-1,3,5,7- | 5% |
| tetramethylcyclotetrasiloxane | |
| Lithium trimethylsilanolate | 1% |

In the formulation provided above, the useful range of the components present in the methylvinylsilyl-functional poly(alkylene glycol)-poly(diorganosiloxane) terpolymer host constituent may be set forth as follows:

| | Percent by |
|---|---|
| Component | Weight |
| Octamethylcyclotetrasiloxane | 5%-95% |
| Poly (dimethylsiloxane) ethoxylated | 1%-50% |
| hydroxypropoxylate terminated, CAS No. [68037-63-8] | |
| 1,3,5,7-Tetravinyl-1,3,5,7- | 1%-50% |
| tetrainethylcyclotetrasiloxane | |
| Lithium trimethylsilanolate | 1-5% |

An alkenyl-functional poly(alkylene glycol)-poly(diorganosiloxane) terpolymer composition based on silanol-functional, carbinol-functional, poly(alkylene ether-co-diorganosiloxane) block copolymers is prepared from the following reagents:

| | Percent by |
|---|---|
| Component | Weight |
| Octamethylcyclotetrasiloxane | 82% |
| Poly (dimethylsiloxane) ethoxylate/propoxylate, | 12% |
| CAS No. [68037-64-9] | |
| 1,3,5,7-Tetravinyl-1,3,5,7- | 5% |
| tetramethylcyclotetrasiloxane | |
| Lithium trimethylsilanolate | 1% |

In the formulation provided above, the useful range of the components present in the methylvinylsilyl-functional poly(alkylene glycol)-poly(diorganosiloxane) terpolymer host constituent may be set forth as follows:

| | Percent by |
|---|---|
| Component | Weight |
| Octamethylcyclotetrasiloxane | 5%-95% |
| Poly (dimethylsiloxane) ethoxylate/propoxylate, | 1%-50% |
| CAS No. [68037-64-9] | |
| 1,3,5,7-Tetravinyl-1,3,5,7- | 1%-50% |
| tetrainethylcyclotetrasiloxane | |
| Lithium trimethylsilanolate | 1-5% |

### EXAMPLE 2

### Syntheses of Molecularly Mixed Blends

Formulations of polysiloxane-polyether liquids from EXAMPLE I, described herein as “Component I”, are blended with monomers chosen from the group consisting of substituted and unsubstituted paraphenylene-vinylenes, anilines, azines, thiophenes, p-phenylene sulfides, furanes, pyrroles, selenophenes, and acetylenes. Aqueous solvent and chemical oxidation agents are added to cause polymerization of the intrinsically conducting polymer within the swollen structure of the Component I.

For example in a typical blend, molecularly mixed blends are prepared from the following reagents:

| Molecularly Mixed Blends | Percent by Weight |
|---|---|
| Component I | 2.6% |
| Monomer | 2.6% |
| Hydrochloric acid | 3.2% |
| Ammonium persulfate | 1.6% |
| Water | 90.0% |

In the formulation provided above, the useful range of the components present in the crosslinkable conductive composite materials may be set forth as follows:

| Component | Percent by Weight |
|---|---|
| Component I | 0.5%-50% |
| Monomer | 0.5%-70% |
| Hydrochloric acid | 0.5%-10% |
| Ammonium persulfate | 0.5%-15% |
| Water | 25%-95% |

In the formulation provided above, the useful range of the components present in the crosslinkable conductive composite materials may be set forth as follows:

| Component | Percent by Weight |
|---|---|
| Component I | 0.5%-50% |
| Monomer | 0.5%-70% |
| Hydrochloric acid | 0.5%-10% |
| Ammonium persulfate | 0.5%-15% |
| Water | 25%-95% |

The properties of the blend can be improved by the inclusion of small amounts of the soluble form of perfluorinated sulfonic acid (CAS 31175-20-9, Nafion® perfluorinated ion-exchange resin, 5 w % solution in a mixture of lower aliphatic alchols and water, Aldrich Chemical, Co.). This is crosslinkable conductive silicone elastomer-polypyrrole nanocomposite composition based on alkenyl-functional poly(alkylene oxide)-poly(diorganosiloxane) terpolymer hosts (Component I as described in preceding section)and organic conducting polymers such as polypyrrole is prepared from the following reagents:

| Component (II) 80:20/50:50 (Nafion-modified) | Percent by Weight |
|---|---|
| Component I | 2.3% |
| Nafion ® perfluorinated ion exchange resin | 0.3% |
| Pyrrole | 2.6% |
| Hydrochloric acid | 3.2% |
| Ammonium persulfate | 1.6% |
| Water | 90.0% |

Pursuant to this embodiment, the following methods were used to prepare molecularly mixed blends.

### Typical Synthesis Procedure of Molecularly Mixed Blends (Component II)

A molecularly mixed blend was synthesized by oxidative solution polymerization of a cyclic monomer in the presence of the functionalized silicone terpolymer and oxidant. The weight % ratio of cyclic monomer to silicone elastomer was typically, 50:50 (w/w). Upon completion of the polymerization, the solid particles were isolated by vacuum filtration. The remaining solids were dried in a vacuum oven overnight at 50° C.

### Synthesis Procedure of Molecularly Mixed Blends (Component II) Containing Perfluorosulfonic Acid

The conducting polymer silicone elastomer was synthesized by oxidative solution polymerization of a cyclic monomer in the presence of the functionalized silicone terpolymer, a soluble form of Nafion® perfluorinated ion exchange resin and oxidant. The weight % ratio of Nafion solids to alkenyl-functional poly(alkylene glycol)-poly(diorganosiloxane) terpolymer was typically, 10:90 (w/w). The weight % ratio of cyclic monomer to silicone elastomer was typically, 50:50 (w/w). Upon completion of the polymerization, the solid particles were isolated by vacuum filtration. The remaining solids were dried in a vacuum oven overnight at 50° C.

### EXAMPLE 3

### Syntheses of the Invention

Hydrosilylation crosslinking chemistry is preferred to render the electrically conductive semisolids from EXAMPLE 2 and referred hereinafter as “Component II”, into the electrically conductive material of the invention. The invention may be prepared from the following reagents:

| Component | Percent by Weight |
|---|---|
| Component II | 70.5% |
| Poly(dimethylsiloxane), vinyl terminated | 14.0% |
| Poly(methylhydrosiloxane, trimethylsilyl terminated | 14.0% |
| Platinum-divinyltetramethyldisiloxane complex | 1.5% |
| (3-3.5% Pt) | |

In the formulation provided above, the useful range of the components present in the crosslinkable conductive composite materials may be set forth as follows:

| Component | Percent by Weight |
|---|---|
| Component II | 5%-90% |
| Poly(dimethylsiloxane), vinyl terminated | 1%-50% |
| Poly(methylhydrosiloxane, trimethylsilyl | 1%-30% |
| terminated | |
| Platinum-divinyltetramethyldisiloxane | 0.1%-10% |
| complex (3-3.5% Pt) | |

### EXAMPLE 4

### Fabrication of Electrically Conductive and Elastomeric Articles

Elastomeric wire was fabricated by extruding Component II through orifice of varying diameter and hydrosilylation crosslinking chemistry used to render Component II into elastomeric solids. Blends were extruded through orifices of varying diameters to produce wires of various diameters. The wires was then coated with an elastomeric non-conductive insulative sheat composed of vinyl-terminated poly(dimethylsiloxane), poly(hydromethylsiloxane), and a platinum-based hydrosilylation catalyst.

The silicone elastomer insulation coating material was prepared according the following formulation.

| Silicone Elastomer Insulation | Percent by Weight |
|---|---|
| Poly(dimethylsiloxane), vinyl terminated | 14.0% |
| Poly(methyihydrosiloxane, trimethylsilyl terminated | 14.0% |
| Platinum-divinyltetramethyldisiloxane complex | 1.5% |
| (3-3.5% Pt) | |

Hydrosilylation is one of the most important and general methods for forming Si—C bonds. The bond-forming chemistry is the platinum or platinum group metal catalyzed reaction between methylhydrosiloxanes and alkenes. In hydrosilylation-curable silicone elastomers, typical formulations are based on vinylmethyl-terminated polysiloxanes or vinylmethyl pendant-functional polysiloxanes with methylhydrosiloxanes. SiH containing siloxanes are well known in the art and can be linear, branched, or cyclic in structure. Examples of SiH containing siloxanes include poly(methylhydrosiloxane) and copolymers such as poly(dimethyl-co-methylhydrosiloxane) Precious metal catalysts suitable for effecting the hydrosilyation reaction are also well known in the art and include complexes of rhodium, ruthenium, palladium, osmium, iridium and platinum. A particularly effective hydrosilylation catalyst is the platinum-divinyltetramethyldisiloxane complex known as Karstedt's catalyst.

### EXAMPLE 5

### Electrical Properties of the Invention

Electrical resistance of 2 mm diameter wire were made at 1 kHz using a Philips Scientific & Industrial Equipment RCL meter Model PM 6303 via platinum wires attached to the invention with conductive silver epoxy. Polyaniline and polypyrrole based wires showed resistivities of about 6 and 12 ohm-cm respectively. Immersion in neutral saline solution at 37° C. for 500 h had little effect on these values.

### EXAMPLE 5

### Mechanical Properties of the Invention

The mechanical properties of the invention were compared with those of a silicone elastomer control. The control was prepared via hydrosilation of the following formulation.

| Silicone Elastomer Control | Percent by Weight |
|---|---|
| Poly(dimethylsiloxane), MW = 28,000 g/mole | 97.9% |
| vinyl terminated | |
| Poly (methylhydrosiloxane), MW = 1,700 g/mole | 2.0% |
| trimethylsilyl terminated | |
| Platinum-divinyl- (3-3.5% Pt) | 0.1% |
| tetramethyldisiloxane complex | |

The elastomeric films were characterized for shear modulus over the temperature range of −20° C. to 200° C. by dynamic mechanical thermal analysis (DMTA) using a Rheometrics Model IV Dynamic Mechanical Thermal Analyzer. Shear modulus data was collected at a cyclic deformation frequency of 1 Hz.

The shear moduli measured over the temperature range of −20° C. to 200° C. for the two films were essentially equivalent and reflect the compliant and thermomechanically stable behavior of silicone-based elastomers and their molecular composites with the invention. A sample of the invention was also analyzed in shear mode by DMTA after immersion at room temperature in deionized water for 24 hours. The shear modulus of the electrode material after water immersion is essentially unchanged from the initial condition over the temperature range for 0° C. to 100° C.

What is claimed is:

1. An electrically conductive material comprising: (A) an intrinsically conducting polymer, and (B) a block copolymer comprising one or more polydiorganosiloxane and one or more polyether block(s).

2. The electrically conductive material of claim 1, wherein said intrinsically conducting polymer is selected from the group consisting of substituted and unsubstituted polyparaphenylenevinylenes, polyanilines, polyazines, polythiophenes, poly-p-phenylene sulfides, polyfuranes, polypyrroles, polyselenophenes, polyacetylenes, formed from soluble precursors and combinations and blends thereof.

3. The electrically conductive material of claim 1, wherein said polydiorganosiloxane block(s) comprise(s) 2 or more diorganosiloxane units which are chosen according to the formula: 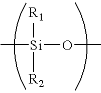
wherein R₁ and R₂ are chosen from the group consisting of methyl, isopropyl, sec-butyl, allyl, phenyl, tolyl, benzyl, —CH₂CH₂CF₃, —CH═CH₂, —(CH₂)ₙ—, —(CH₂)ₙ(OCH₂CH₂)ₓOR₃, —(CH₂)ₙ(OCH₂CH₂)ₓ(OCH₂CH₂CH₂)_{y}OR₃ and —(CH₂)ₙ—R₄; wherein n equals an integer from 1 to about 18; the sum of x and y is an integer from 1 to about 5000; R₃is chosen from the group consisting of H and CH₃; and R₄ is chosen from the group consisting of substituted and unsubstituted paraphenylenevinylenes, anilines, azines, thiophenes, p-phenylene sulfides, furanes, pyrroles, selenophenes, and acetylenes.

4. The electrically conductive material of claim 1, wherein said polyether block(s) comprise ether units which are chosen from the group consisting of ethylene oxide and propylene oxide.

5. The electrically conductive material of claim 3, wherein said diorganosiloxane units range in number from about 4 to about 500 and at least half of R₁ and R₂ are methyl.

6. The electrically conductive material of claim 3, wherein n equals three.

7. The electrically conductive material of claim 4, wherein said ether units range in number from about 5 to about 500.

8. The electrically conductive material of claim 1, wherein said material is an elastomer.
